(19) United States
(12) Patent Application Publication
(10) Pub. No.: US 2025/0300983 A1
(43) Pub. Date: Sep. 25, 2025

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Keisuke KOMATSUBARA, Kanagawa (JP)

(73) Assignee: FUJIFILM Business Innovation Corp., Tokyo (JP)

(21) Appl. No.: 18/779,754

(22) Filed: Jul. 22, 2024

(30) Foreign Application Priority Data
Mar. 21, 2024 (JP) 2024-045201

(51) Int. Cl. H04L 9/40; H04L 61/45

(52) U.S. Cl. CPC H04L 63/10; H04L 61/45

(57) ABSTRACT

An information processing system includes a processor and a memory. The memory is configured to store information indicating a destination of an access destination system and information indicating an operation prohibited for the access destination system in an associated manner, and the processor is configured to: in a case where an access destination system and an operation to be performed on the system are designated by a user, when information indicating a destination of the system designated by the user and information indicating the operation designated by the user are not stored in the memory in an associated manner, request a name resolution system to perform name resolution based on the information indicating the destination of the system designated by the user and access the system according to an address acquired in response to the request; and when the information indicating the destination of the system designated by the user and the information indicating the operation designated by the user are stored in the memory in an associated manner, not request a name resolution system to perform name resolution based on the information indicating the destination of the system designated by the user.

### CROSS-REFERENCE TO RELATED APPLICATIONS

This application is based on and claims priority under 35 USC 119 from Japanese Patent Application No. 2024-045201 filed Mar. 21, 2024.

### BACKGROUND

### (i) Technical Field

The present disclosure relates to an information processing system, a non-transitory computer readable medium, and an information processing method.

### (ii) Related Art

Since name resolution by Domain Name System (DNS) is intended for plain text, a security problem may occur. In order to cope with this, DoH (DNS over Hypertext Transfer Protocol Secure (HTTPS)) utilizing encryption of HTTPS may be used.

Japanese Unexamined Patent Application Publication (Translation of PCT Application) No. 2014-519751 describes a system that extracts a domain name from a DNS request and determines, based on a policy, whether to permit access to the domain name.

Japanese Unexamined Patent Application Publication No. 2017-135622 describes a packet filtering device that acquires an electronic certificate from a server when Transport Layer Security (TLS) connection is performed, and updates IP address information using a destination IP address of a connection packet when a host name extracted from the electronic certificate is included in filtering condition information. The packet filtering device determines whether a communication packet transmitted from a terminal apparatus is allowed to pass on the basis of whether or not a destination IP address of the communication packet is included in the IP address information.

### SUMMARY

However, since information indicating a destination is also encrypted in the DoH, it is not possible to determine whether to permit access in a system that determines whether to permit access using a fully qualified domain name (FQDN), which is an example of information indicating a destination. In order to cope with the encryption of the DNS, it is conceivable to determine whether to permit the access by analyzing the TLS connection of every communication, but there is a risk that a load on a system for determining whether to permit the access increases. Furthermore, in a case where whether to permit access is determined only on the basis of information indicating a destination, such as a domain name, access may be prohibited even in a case where a security problem cannot occur.

Aspects of non-limiting embodiments of the present disclosure relate to suppressing an increase in a load required for determination as compared with a case where whether to permit access is determined using an electronic certificate, and to preventing unnecessary prohibition of access to an access destination system as compared with a case where whether to permit access is determined using only information indicating a destination. Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor and a memory, wherein the memory is configured to store information indicating a destination of an access destination system and information indicating an operation prohibited for the access destination system in an associated manner, and the processor is configured to: in a case where an access destination system and an operation to be performed on the system are designated by a user, when information indicating a destination of the system designated by the user and information indicating the operation designated by the user are not stored in the memory in an associated manner, request a name resolution system to perform name resolution based on the information indicating the destination of the system designated by the user and access the system according to an address acquired in response to the request; and when the information indicating the destination of the system designated by the user and the information indicating the operation designated by the user are stored in the memory in an associated manner, not request a name resolution system to perform name resolution based on the information indicating the destination of the system designated by the user.

### BRIEF DESCRIPTION OF THE DRAWINGS

Exemplary embodiments of the present disclosure will be described in detail based on the following figures, wherein:

FIG. 1 is a block diagram illustrating an example of an entire system according to the exemplary embodiment;

FIG. 2 is a block diagram illustrating an example of hardware of an image forming apparatus according to the exemplary embodiment;

FIG. 3 is a table illustrating an example of a prohibition condition list;

FIG. 4 is a diagram illustrating a flowchart which shows an example of processing by an image forming apparatus according to the exemplary embodiment; and

FIG. 5 is a block diagram illustrating an example of an entire system according to a modification example.

### DETAILED DESCRIPTION

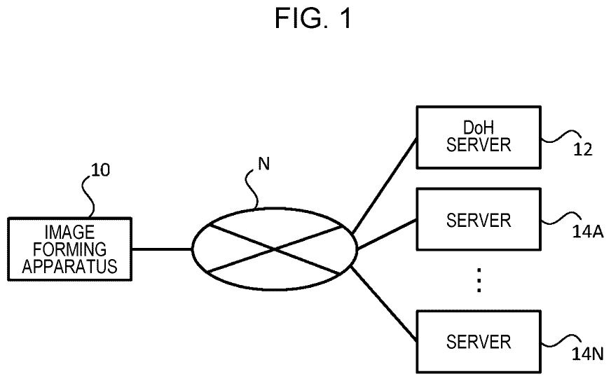

With reference to FIG. 1, an example of an entire system according to an exemplary embodiment will be described. FIG. 1 is a block diagram illustrating an example of an entire system according to the exemplary embodiment.

For example, the entire system according to the exemplary embodiment includes an image forming apparatus 10, a DoH server 12, and servers 14A to 14N. Hereinafter, when it is not necessary to distinguish the servers 14A to 14N from each other, each of the servers 14A to 14N is referred to as a “server 14”. In the example illustrated in FIG. 1, a plurality of servers 14 is included in the entire system, but the number of servers 14 included in the entire system may be one. Further, a plurality of image forming apparatuses 10 may be included in the entire system.

The image forming apparatus 10 is an example of an information processing system. Each server 14 is an example of an access destination system.

The image forming apparatus 10, the DoH server 12, and the server 14 communicate with other apparatuses via a communication path N. The communication path N is, for example, a network such as the Internet. The communication path N may include a local area network (LAN) or the like. A part or all of the communication path N may be constructed by wired communication or may be constructed by wireless communication such as Wi-Fi (registered trademark).

The image forming apparatus 10 is a printer, a scanner, a copier, a facsimile machine, or a multifunction apparatus (for example, an apparatus having functions of a plurality of apparatuses such as a printer, a scanner, and a copier). The image forming apparatus 10 executes jobs such as a print job, a scan job, and a copy job.

The image forming apparatus 10 has at least one of a function of downloading a file such as document data or image data from the server 14 and a function of uploading a file to the server 14. For example, the image forming apparatus 10 has a function of downloading a file from the server 14 and printing the file, and a function of uploading a file generated by scanning a document to the server 14. In addition, the image forming apparatus 10 may receive a file from a terminal apparatus such as a personal computer or a smartphone and print the file, or may transmit a file generated by scanning a document to a terminal apparatus.

Examples of the operation using the image forming apparatus 10 and the server 14 include an operation in which the image forming apparatus 10 downloads a file from the server 14 on the cloud and prints the file, an operation in which the image forming apparatus 10 generates a file such as image data by scanning a document and transmits the file to the server 14 on the cloud, and an operation in which the image forming apparatus 10 transmits image data such as document data received by facsimile to the server 14 on the cloud. Of course, operations other than these may be realized by the image forming apparatus 10 and the server 14.

The DoH server 12 is a server that performs name resolution through encrypted communication. That is, the DoH server 12 is a server for converting between a domain name and an IP address. Specifically, the DoH server 12 converts the domain name into the IP address (i.e., forward lookup), or converts the IP address into the domain name (i.e., reverse lookup). An example of a method of performing name resolution via encrypted communication includes DoH, but encrypted communication other than DoH may be used.

The server 14 is an online storage such as a cloud storage, a server that provides various online services and web applications, or the like.

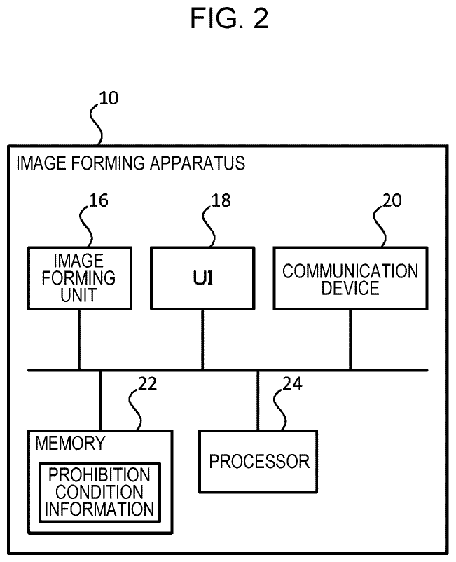

Hereinafter, the image forming apparatus 10 will be described with reference to FIG. 2. FIG. 2 is a block diagram illustrating an example of hardware of the image forming apparatus 10.

The image forming apparatus 10 includes an image forming unit 16, a UI 18, a communication device 20, a memory 22, and a processor 24.

The image forming unit 16 has at least one of a print function, a scan function, a copy function, and a facsimile function. Note that a printing method, a scanning method, and the like are not particularly limited. For example, as a printing method, an electrophotographic method, an inkjet method, a thermal method, a thermal transfer method, or the like is used.

The UI 18 is a user interface and includes a display and an operation device. The display is a liquid crystal display, an EL display, or the like. The operation device is a keyboard, a mouse, an input key, an operation panel, or the like. The UI 18 may be a touch panel UI having both a display and an operation device. The UI 18 receives an operation from a user. Further, by using the UI 18, prohibition condition information described later may be changed by the user.

The communication device 20 includes one or more communication interfaces having a communication chip, a communication circuit, and the like, and has a function of transmitting data to another device and a function of receiving data from another device. The communication device 20 may have a wireless communication function or a wired communication function.

The memory 22 is a device that forms one or more storage areas for storing data. The memory 22 is, for example, a hard disk drive (HDD), a solid state drive (SSD), various memories (for example, a RAM, a DRAM, an NVRAM, a ROM, and the like), other storage devices (for example, an optical disc and the like), or a combination of these.

The prohibition condition information is stored in the memory 22 in advance. The prohibition condition information is information for determining whether to permit access to each system from the image forming apparatus 10, and is information indicating an operation that is prohibited for the access destination system, a user whose operation is prohibited, and the like. As described above, the server 14 is an example of the system herein. That is, the prohibition condition information is information for determining whether to permit access to each of the servers 14 from the image forming apparatus 10, and is information indicating an operation that is prohibited for the server 14 of the access destination, a user whose operation is prohibited, and the like.

For example, for each server 14, information indicating a destination of the server 14 (hereinafter, referred to as “destination information”) and information indicating an operation prohibited for the server 14 (hereinafter referred to as “prohibited operation”) (hereinafter, referred to as “prohibited operation information”) are included in the prohibition condition information in association with each other in advance.

For each server 14, destination information of the server 14, prohibited operation information indicating an operation prohibited for the server 14, and information for identifying a user whose operation is prohibited (hereinafter referred to as a “prohibited user”) (hereinafter, referred to as “prohibited user information”) may be included in the prohibition condition information in association with each other in advance.

The destination information is, for example, a domain name such as an FQDN. The prohibited operation is, for example, transfer of a file, posting of a file, reception of a file, or the like. The prohibited user information is, for example, information indicating an account associated with the prohibited user, information indicating a name of the prohibited user, a user ID associated with the prohibited user, or information indicating an attribute or a type of the prohibited user.

When the name resolution is performed, the processor 24 determines whether to permit access to the system (for example, the server 14) in accordance with the prohibition condition information.

In a case where an access destination system (for example, a certain server 14) and an operation to be performed on the system are designated by a user, when destination information of the system designated by the user and information indicating the operation designated by the user are not included in the prohibition condition information in an associated manner, the processor 24 requests a name resolution system (for example, the DoH server 12) to perform name resolution based on the destination information of the system designated by the user. For example, the processor 24 transmits the destination information of the system designated by the user to the DoH server 12, and requests the DoH server 12 to perform name resolution based on the destination information. In response to the request, the DoH server 12 converts the destination information transmitted from the image forming apparatus 10 into an IP address, and transmits the IP address to the image forming apparatus 10. The processor 24 accesses the system designated by the user according to the IP address acquired in response to the name resolution request.

In a case where an access destination system (for example, a certain server 14) and an operation to be performed on the system are designated by a user, when destination information of the system designated by the user and information indicating the operation designated by the user are included in the prohibition condition information in an associated manner, the processor 24 does not request a name resolution system (for example, the DoH server 12) to perform name resolution based on the destination information of the system designated by the user.

That is, when the operation designated by a user does not correspond to the prohibited operation for the access destination system designated by the user, the processor 24 requests the DoH server 12 to perform the name resolution based on the destination information of the system designated by the user.

When the operation designated by a user corresponds to the prohibited operation for the access destination system designated by the user, the processor 24 does not request the DoH server 12 to perform the name resolution based on the destination information of the system designated by the user.

The access destination system and the operation to be performed on the system are designated, for example, via the UI 18. That is, the user designates, by using the UI 18, the access destination system and the operation to be performed on the system. In another example, the access destination system and the operation to be performed on the system may be designated via a terminal apparatus (for example, a personal computer, a smartphone, or the like) connected to the image forming apparatus 10.

When the destination information, the prohibited operation information, and the prohibited user information are included in the prohibition condition information in association with each other in advance, the processor 24 may execute the following processing

In a case where an access destination system (for example, a certain server 14) and an operation to be performed on the system are designated by a user, when destination information of the system designated by the user, information indicating the operation designated by the user, and information indicating the user are not included in the prohibition condition information in an associated manner, the processor 24 requests a name resolution system (for example, the DoH server 12) to perform name resolution based on the destination information of the system designated by the user. The processor 24 accesses the system designated by the user according to the IP address acquired in response to the name resolution request.

The information indicating the user is, for example, information indicating an account associated with the user, information indicating a name of the user, a user ID associated with the user, or the like. For example, when a user logs in to the image forming apparatus 10, the user inputs the information indicating the user (for example, information indicating an account, or the like) to the image forming apparatus 10 via the UI 18. The information indicating the user may be input to the image forming apparatus 10 by using an IC card, a smartphone, or another mobile terminal.

In a case where an access destination system (for example, a certain server 14) and an operation to be performed on the system are designated by a user, when destination information of the system designated by the user, information indicating the operation designated by the user, and information indicating the user are included in the prohibition condition information in an associated manner, the processor 24 does not request a name resolution system (for example, the DoH server 12) to perform name resolution based on the destination information of the system designated by the user.

That is, even in a case where the operation designated by the user corresponds to the prohibited operation for the access destination system designated by the user, when the user does not correspond to the prohibited user for the access destination system designated by the user, the processor 24 requests the DoH server 12 to perform name resolution based on the destination information of the system designated by the user. Furthermore, also in a case where the operation designated by the user does not correspond to the prohibited operation for the access destination system designated by the user, the processor 24 requests the DoH server 12 to perform name resolution based on the destination information of the system designated by the user.

When the operation designated by the user corresponds to the prohibited operation for the access destination system designated by the user and the user corresponds to the prohibited user for the access destination system designated by the user, the processor 24 does not request the DoH server 12 to perform name resolution based on the destination information of the system designated by the user.

Note that in addition to the above-described processing, the processor 24 controls the operation of each unit of the image forming apparatus 10.

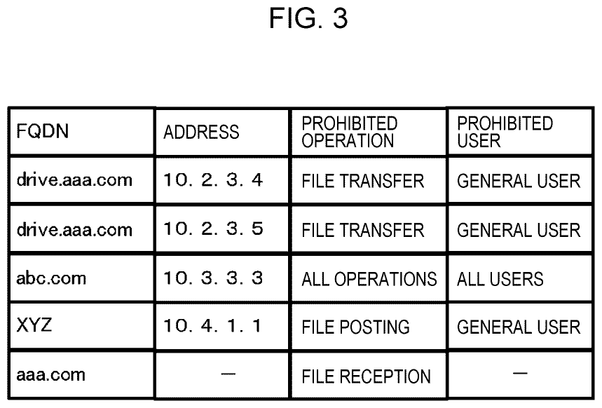

Hereinafter, an example of the prohibition condition information will be described with reference to FIG. 3. FIG. 3 is a table illustrating an example of a prohibition condition list. The prohibition condition list illustrated in FIG. 3 is an example of prohibition condition information.

For example, in the prohibition condition list, for each server 14, a domain name (for example, an FQDN) of the server 14, an address (for example, an IP address) of the server 14, information indicating a prohibited operation for the server 14, and information indicating a prohibited user are associated with each other. In the example illustrated in FIG. 3, the address (for example, the IP address) of the server 14 is included in the prohibition condition list, but the address of the server 14 may not be included in the prohibition condition list.

In the example illustrated in FIG. 3, file transfer, file posting, and file reception are included in the prohibition condition list as an example of the prohibited operation. The file transfer is an operation (for example, upload) of transmitting a file from the image forming apparatus 10 to the server 14 of the access destination. The file posting is an operation of posting a file to an online service or a web application. The file reception is an operation (for example, download) in which the image forming apparatus 10 receives a file from the server 14 of the access destination.

In the example illustrated in FIG. 3, a general user and all users are included in the prohibition condition list as an example of prohibited users. The general user is an attribute or a type of a user. The prohibited operation associated with the general user is an operation prohibited from being performed by a user having the attribute of the general user. As an example other than the example illustrated in FIG. 3, information indicating an account of each user or a user ID may be included in the prohibition condition list as information indicating the prohibited user.

For example, for the server 14 having the FQDN “drive.aaa.com”, the operation of“file transfer” by a user having the attribute of “general user” is prohibited. For the server 14 having the FQDN “abc.com”, “all operations” by “all users” are prohibited. For the server 14 having the FQDN “XYZ”, the operation of “file posting” by a user having the attribute of “general user” is prohibited. For the server 14 having the FQDN “aaa.com”, the operation of “file reception” is prohibited.

Although the FQDN is used as a domain name in the example illustrated in FIG. 3, each server 14 may be specified by a domain name other than the FQDN. Further, the prohibited operations and the prohibited users shown in FIG. 3 are merely examples, and prohibited operations other than the prohibited operations shown in FIG. 3 and prohibited users other than the prohibited users shown in FIG. 3 may be included in the prohibition condition list. Furthermore, a type of a file (for example, a confidential document or a document that is permitted to be published) may be included in the prohibition condition list as a prohibition condition.

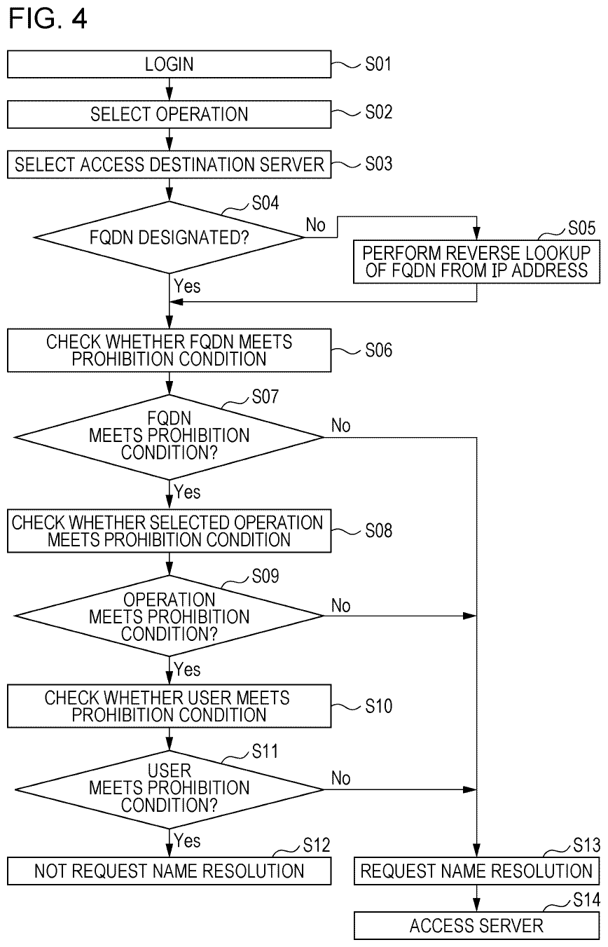

Hereinafter, an example of processing by the image forming apparatus 10 will be described with reference to FIG. 4. FIG. 4 is a flowchart illustrating a flow of the processing.

First, the user inputs user information (for example, information indicating an account) of the user himself/herself to the image forming apparatus 10 using the UI 18, and logs in to the image forming apparatus 10 (S01). Thus, the image forming apparatus 10 identifies the user who has logged in to the image forming apparatus 10.

Next, the user selects an operation desired by the user using the UI 18 (S02). Here, as an example, an application is selected as the operation. When an application is selected by the user, the selected application is activated. Here, as an example, a scan application is selected. The scan application is an application that generates a file (for example, document data or image data) by the image forming apparatus 10 scanning a document and transmits the file to the server 14 of the access destination, and is an example of the operation.

Next, the user uses the UI 18 to select the access destination server 14 (S03). For example, the user selects the server 14 of the transmission destination of the file generated by scanning. For example, a list of the server 14 is displayed on the display of the UI 18, and the user selects the server 14 of the transmission destination from the list. Note that the server 14 of the transmission destination is an example of the server 14 of the access destination. As another example, the user may input the URL of the access destination server 14 into the image forming apparatus 10 by using the UI 18.

In step S03, when the access destination server 14 is selected by the IP address rather than the FQDN, the processor 24 checks whether or not the IP address is included in the prohibition condition list. For example, when the user selects the server 14 as the access destination by inputting or designating the IP address in step S03, the processor 24 checks whether or not the IP address is included in the prohibition condition list.

When the IP address input or designated by the user is included in the prohibition condition list, the processor 24 prohibits access to the server 14 to which the IP address is assigned. In this case, the application selected by the user is not executed, and the process ends.

When the IP address input or designated by the user is not included in the prohibition condition list (S04, No), processing of reverse lookup of the FQDN from the IP address is performed (S05). The processor 24 transmits the IP address to the DoH server 12, and requests the DoH server 12 to perform the reverse lookup. The DoH server 12 performs the reverse lookup of the FQDN from the IP address and transmits the FQDN to the image forming apparatus 10. In this way, the image forming apparatus 10 acquires the FQDN of the server 14 of the access destination. Thereafter, the process proceeds to step S06.

When the server 14 of the access destination is selected by the FQDN in step S03 (S04, Yes), or when the FQDN is acquired by the reverse lookup, the processor 24 checks whether or not the FQDN is included in the prohibition condition list (S06).

When the FQDN is not included in the prohibition condition list (S07, No), the process proceeds to step S13. In step S13, the processor 24 requests the DoH server 12 to perform name resolution. The processing in step S13 will be described later in detail.

When the FQDN is included in the prohibition condition list (S07, Yes), the processor 24 determines whether or not the operation selected by the user is included in the prohibition condition list (S08). Specifically, the processor 24 checks whether or not the FQDN and the operation selected by the user are included in the prohibition condition list in an associated manner. That is, the processor 24 checks whether or not the operation selected by the user is prohibited for the server 14 having the FQDN. In the above-described example, the processor 24 checks whether or not the FQDN and the scan application selected by the user are included in the prohibition condition list in an associated manner.

When the FQDN and the operation selected by the user (for example, the scan application) are not included in the prohibition condition list in an associated manner (S09, No), the process proceeds to step S13.

When the FQDN and the operation selected by the user (for example, the scan application) are included in the prohibition condition list in an associated manner (S09, Yes), the processor 24 checks whether or not the user who has logged in to the image forming apparatus 10 is included in the prohibition condition list (S10). That is, the processor 24 checks whether or not the user is associated with the FQDN and the operation as a prohibited user.

When the user is not included in the prohibition condition list as a prohibited user in association with the FQDN and the operation (S11, No), the process proceeds to step S13.

When the user is included in the prohibition condition list as a prohibited user in association with the FQDN and the operation (S11, Yes), the processor 24 does not request the DoH server 12 to perform name resolution (S12). That is, the processor 24 does not request the DoH server 12 to perform name resolution for converting the FQDN of the server 14 designated by the user into the IP address. In this case, the operation selected by the user (for example, the scan application) is not executed, and the process ends.

In step S13, the processor 24 transmits the FQDN of the server 14 designated by the user to the DoH server 12, and requests the DoH server 12 to perform the name resolution for converting the FQDN into the IP address. In response to the request, the DoH server 12 converts the FQDN transmitted from the image forming apparatus 10 into an IP address, and transmits the IP address to the image forming apparatus 10. In this way, the processor 24 acquires the IP address corresponding to the FQDN of the server 14 designated by the user.

When acquiring the IP address from the DoH server 12, the processor 24 accesses the server 14 to which the IP address is assigned according to the IP address (S14). When a file of image data or the like is generated in the image forming apparatus 10 by executing the scan application, the processor 24 transmits (for example, uploads) the generated file to the server 14 to which the IP address is assigned. In this way, the operation selected by the user is executed.

According to the present exemplary embodiment, since it is not necessary to determine whether to permit access to the server 14 using an electronic certificate, it is possible to suppress an increase in the load required for the determination as compared with the case of determining whether to permit access using an electronic certificate.

Furthermore, since whether to permit access is determined using not only the destination information but also the operation prohibition information, it is possible to prevent unnecessary prohibition of access to the server 14 of the access destination, as compared with a case where whether to permit access is determined using only the destination information. That is, when determining whether to permit access to the server 14 only by the destination information, access to the server 14 may be prohibited even in a case where an operation that is not prohibited for the server 14 is performed. According to the present exemplary embodiment, when an operation that is not prohibited for the server 14 is designated by the user, access to the server 14 may be permitted, so that unnecessary prohibition of access is prevented.

### MODIFICATION EXAMPLE

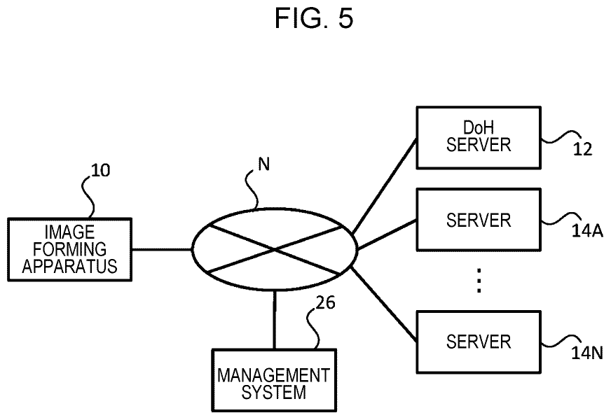

A modification example will be described with reference to FIG. 5. FIG. 5 is a diagram illustrating an example of an entire system according to the modification example. The entire system according to the modification example includes a management system 26. The configuration other than the management system 26 is the same as the configuration shown in FIG. 1.

The management system 26 manages the prohibition condition list and provides the prohibition condition list to the image forming apparatus 10. In a case where the plurality of image forming apparatuses 10 is connected to the management system 26 via the communication path N, the management system 26 provides the prohibition condition list to each of the image forming apparatuses 10. For example, the management system 26 includes a processor and a memory. The processor of the management system 26 provides the prohibition condition list to each of the image forming apparatuses 10.

For example, for each server 14, destination information of the server 14, operation prohibition information indicating an operation prohibited for the server 14, and an address (for example, an IP address) of the server 14 are stored in the memory of the management system 26 in association with each other, and are managed by the management system 26.

For each server, destination information of the server 14, operation prohibition information indicating an operation prohibited for the server 14, an address (for example, an IP address) of the server 14, and prohibited user information of a user whose operation is prohibited (that is, a prohibited user) may be stored in the memory of the management system 26 in association with each other and managed by the management system 26. For example, the prohibition condition list shown in FIG. 3 may be stored in the memory of the management system 26 and managed by the management system 26. That is, for each server 14, the FQDN of the server 14, the IP address of the server 14, the prohibited operation information indicating an operation prohibited for the server 14, and the prohibited user information indicating a prohibited user whose operation is prohibited may be stored in the memory of the management system 26 in association with each other and managed by the management system 26.

The processor 24 of the image forming apparatus 10 acquires the prohibition condition list from the management system 26 via the communication path N and stores the prohibition condition list in the memory 22 of the image forming apparatus 10. For example, acquiring the prohibition condition list from the management system 26 is set for the image forming apparatus 10. The processor 24 acquires the prohibition condition list from the management system 26 in accordance with the setting.

For example, the processor 24 accesses the management system 26 at a predetermined timing or a timing specified by the user, acquires the prohibition condition list from the management system 26, and stores the prohibition condition list in the memory 22. The processor 24 determines, according to the prohibition condition list stored in the memory 22, whether to permit the request for name resolution.

For example, the above timing is the time of activation of the image forming apparatus 10. In this case, when the image forming apparatus 10 is activated by turning on the power of the image forming apparatus 10, the processor 24 accesses the management system 26, acquires the prohibition condition list from the management system 26, and stores the prohibition condition list in the memory 22.

The time of activation is an example of the timing, and the processor 24 may acquire the prohibition condition list from the management system 26 at a timing other than the time of activation. For example, the processor 24 may acquire the prohibition condition list from the management system 26 at a timing specified by the user after the image forming apparatus 10 is activated. As another example, the processor 24 may acquire the prohibition condition list from the management system 26 at predetermined time intervals (for example, every 10 minutes, every hour, or every day). These settings may be changed by an administrator or a user.

In a case where a condition included in the prohibition condition list is changed, the prohibition condition list stored in the management system 26 is changed. For example, when a condition included in the prohibition condition list is changed, the administrator changes the prohibition condition list stored in the management system 26. In this way, even when the administrator or the user does not manually change the prohibition condition list stored in the memory 22 of the image forming apparatus 10, the prohibition condition list stored in the memory 22 of the image forming apparatus 10 is updated. For example, in a case where the plurality of image forming apparatuses 10 is included in the entire system, each of the plurality of image forming apparatuses 10 acquires the prohibition condition list from the management system 26, and thus the prohibition condition list stored in each of the image forming apparatuses 10 is updated without the administrator or the user individually changing the prohibition condition list in each of the image forming apparatuses 10. Of course, the prohibition condition list may be individually set for each of the image forming apparatuses 10 without acquiring the prohibition condition list from the management system 26.

In the modification example, when the IP address that is included in the prohibition condition list stored in the memory 22 and is associated with the destination information (for example, FQDN) of the server 14 designated by the user is different from the IP address acquired by the image forming apparatus 10 through the name resolution by the DoH server 12 based on the destination information (for example, FQDN) of the server 14 designated by the user, the processor 24 requests the management system 26 to change the prohibition condition list stored in the management system 26. That is, for the destination information (for example, FQDN) of the server 14 designated by the user, when the IP address stored in the memory 22 is different from the IP address acquired by the name resolution by the DoH server 12, the processor 24 requests the management system 26 to change the prohibition condition list stored in the management system 26.

That is, in a case where the name resolution is performed by the DoH server 12, for the destination information (for example, FQDN) of the server 14 designated by the user, when the IP address included in the prohibition condition list stored in the memory 22 and the IP address acquired from the DoH server 12 are different, the processor 24 determines that the prohibition condition list is old.

For example, in a case where an IP address of a certain server 14 is changed, the IP address of the server 14 registered in the DoH server 12 is changed, but the IP address of the server 14 included in the prohibition condition list stored in the management system 26 may not be changed. In this case, even for the destination information of the same server 14, the IP address included in the prohibition condition list stored in the memory 22 may be different from the IP address acquired from the DoH server 12. In this case, the processor 24 requests the management system 26 to change the prohibition condition list.

For example, the processor 24 requests the management system 26 to change the prohibition condition list by transmitting request information indicating a request to change the prohibition condition list to the management system 26.

Upon receiving the request information from the image forming apparatus 10, the processor of the management system 26 checks whether or not there is a difference between the destination information and the IP address included in the prohibition condition list stored in the management system 26 and the destination information and the IP address stored in the DoH server 12.

For example, the processor of the management system 26 acquires the destination information (for example, FQDN) and the IP address of each server 14 from the DoH server 12, compares the destination information and the IP address included in the prohibition condition list stored in the management system 26 with the destination information and the IP address acquired from the DoH server 12, and checks whether or not there is a difference therebetween.

When there is a difference, the processor of the management system 26 updates the prohibition condition list by changing the destination information and the IP address included in the prohibition condition list stored in the management system 26 to the destination information and the IP address acquired from the DoH server 12. When there is no difference, the processor of the management system 26 does not update the prohibition condition list stored in the management system 26.

The processor 24 of the image forming apparatus 10 acquires the prohibition condition list from the management system 26 at a predetermined timing and updates the prohibition condition list stored in the memory 22 of the image forming apparatus 10.

Some of the functions of the image forming apparatus 10 may be realized by an apparatus other than the image forming apparatus 10. In a case where some of the functions of the image forming apparatus 10 are realized by an apparatus other than the image forming apparatus 10, the image forming apparatus 10 and the other apparatus may constitute an information processing system. That is, the functions of the image forming apparatus 10 may be realized by a single apparatus or may be realized by an information processing system including a plurality of apparatuses. The same applies to the DoH server 12, the server 14, and the management system 26.

Each function of the image forming apparatus 10 is realized by cooperation of hardware and software, as one example. For example, the processor 24 of the image forming apparatus 10 reads and executes a program stored in the memory, thereby realizing each function of the image forming apparatus 10. The program is stored in the memory via a recording medium such as a CD or a DVD, or via a communication path such as a network.

Although the image forming apparatus 10 has been described in the above-described exemplary embodiment and modification example, the exemplary embodiment and the modification example may be applied to apparatuses other than the image forming apparatus 10. For example, when a personal computer or a smartphone accesses the server 14 to upload a file to the server 14 or download a file from the server 14, the above-described exemplary embodiment and modification example may be applied. Furthermore, when a proxy server is used, the above-described exemplary embodiment and modification example may also be applied.

In the above exemplary embodiment, the processor refers to a processor in a broad sense, and includes general-purpose processors (for example, Central Processing Unit (CPU) and the like) and dedicated processors (for example, Graphics Processing Unit (GPU), Application Specific Integrated Circuit (ASIC), Field Programmable Gate Array (FPGA), programmable logic devices, and the like). Further, the operation of the processor in the above exemplary embodiment may be performed not only by one processor but also by a plurality of processors existing at physically separated positions in cooperation with each other. In addition, the order of the respective operations of the processor is not limited to only the order described in the above exemplary embodiment but may be appropriately changed.

### APPENDIX

(((1)))

An information processing system comprising:
a processor; and
a memory, wherein
the memory is configured to store information indicating a destination of an access destination system and information indicating an operation prohibited for the access destination system in an associated manner, and
the processor is configured to:
in a case where an access destination system and an operation to be performed on the system are designated by a user,
   when information indicating a destination of the system designated by the user and information indicating the operation designated by the user are not stored in the memory in an associated manner, request a name resolution system to perform name resolution based on the information indicating the destination of the system designated by the user and access the system according to an address acquired in response to the request; and
   when the information indicating the destination of the system designated by the user and the information indicating the operation designated by the user are stored in the memory in an associated manner, not request a name resolution system to perform name resolution based on the information indicating the destination of the system designated by the user.
      (((2)))

The information processing system according to (((1))), wherein
the memory is further configured to store information indicating a destination of an access destination system, information indicating an operation prohibited for the access destination system, and information indicating a user prohibited from performing the operation in an associated manner, and
the processor is configured to:
   when information indicating a destination of a system designated by the user, information indicating an operation designated by the user, and information indicating the user are not stored in the memory in an associated manner, request a name resolution system to perform name resolution based on the information indicating the destination of the system designated by the user and access the system according to an address acquired in response to the request; and
   when the information indicating the destination of the system designated by the user, the information indicating the operation designated by the user, and the information indicating the user are stored in the memory in an associated manner, not request a name resolution system to perform name resolution based on the information indicating the destination of the system designated by the user.
      (((3)))

The information processing system according to (((1))), wherein
information indicating a destination of an access destination system, information indicating an operation prohibited for the access destination system, and an address of the access destination system are managed in an associated manner by a management system,
the processor is further configured to acquire the information indicating the destination of the access destination system, the information indicating the operation prohibited for the access destination system, and the address of the access destination system, which are associated with each other, from the management system and store them in the memory, and
the processor is further configured to, when the address stored in the memory in association with the information indicating the destination of the system designated by the user and the address acquired by name resolution based on the information indicating the destination of the system designated by the user are different, request the management system to change association of the information indicating the destination of the access destination system, the information indicating the operation prohibited for the access destination system, and the address of the access destination system.
   (((4)))

A program causing a computer to execute a process, the computer including a memory configured to store information indicating a destination of an access destination system and information indicating an operation prohibited for the access destination system in an associated manner, the process comprising:
in a case where an access destination system and an operation to be performed on the system are designated by a user,
   when information indicating a destination of the system designated by the user and information indicating the operation designated by the user are not stored in the memory in an associated manner, requesting a name resolution system to perform name resolution based on the information indicating the destination of the system designated by the user and accessing the system according to an address acquired in response to the request; and
   when the information indicating the destination of the system designated by the user and the information indicating the operation designated by the user are stored in the memory in an associated manner, not requesting a name resolution system to perform name resolution based on the information indicating the destination of the system designated by the user.
      (((5)))

An information processing method comprising:
by a computer including a memory configured to store information indicating a destination of an access destination system and information indicating an operation prohibited for the access destination system in an associated manner,
in a case where an access destination system and an operation to be performed on the system are designated by a user,
   when information indicating a destination of the system designated by the user and information indicating the operation designated by the user are not stored in the memory in an associated manner, requesting a name resolution system to perform name resolution based on the information indicating the destination of the system designated by the user and accessing the system according to an address acquired in response to the request; and
   when the information indicating the destination of the system designated by the user and the information indicating the operation designated by the user are stored in the memory in an associated manner, not requesting a name resolution system to perform name resolution based on the information indicating the destination of the system designated by the user.

What is claimed is:

1. An information processing system comprising:
a processor; and
a memory, wherein
the memory is configured to store information indicating a destination of an access destination system and information indicating an operation prohibited for the access destination system in an associated manner, and
the processor is configured to:
in a case where an access destination system and an operation to be performed on the system are designated by a user,
when information indicating a destination of the system designated by the user and information indicating the operation designated by the user are not stored in the memory in an associated manner, request a name resolution system to perform name resolution based on the information indicating the destination of the system designated by the user and access the system according to an address acquired in response to the request; and
when the information indicating the destination of the system designated by the user and the information indicating the operation designated by the user are stored in the memory in an associated manner, not request a name resolution system to perform name resolution based on the information indicating the destination of the system designated by the user.

2. The information processing system according to claim 1, wherein
the memory is further configured to store information indicating a destination of an access destination system, information indicating an operation prohibited for the access destination system, and information indicating a user prohibited from performing the operation in an associated manner, and
the processor is configured to:
when information indicating a destination of a system designated by the user, information indicating an operation designated by the user, and information indicating the user are not stored in the memory in an associated manner, request a name resolution system to perform name resolution based on the information indicating the destination of the system designated by the user and access the system according to an address acquired in response to the request; and
when the information indicating the destination of the system designated by the user, the information indicating the operation designated by the user, and the information indicating the user are stored in the memory in an associated manner, not request a name resolution system to perform name resolution based on the information indicating the destination of the system designated by the user.

3. The information processing system according to claim 1, wherein
information indicating a destination of an access destination system, information indicating an operation prohibited for the access destination system, and an address of the access destination system are managed in an associated manner by a management system,
the processor is further configured to acquire the information indicating the destination of the access destination system, the information indicating the operation prohibited for the access destination system, and the address of the access destination system, which are associated with each other, from the management system and store them in the memory, and
the processor is further configured to, when the address stored in the memory in association with the information indicating the destination of the system designated by the user and the address acquired by name resolution based on the information indicating the destination of the system designated by the user are different, request the management system to change association of the information indicating the destination of the access destination system, the information indicating the operation prohibited for the access destination system, and the address of the access destination system.

4. A non-transitory computer readable medium storing a program causing a computer to execute a process, the computer including a memory configured to store information indicating a destination of an access destination system and information indicating an operation prohibited for the access destination system in an associated manner, the process comprising:
in a case where an access destination system and an operation to be performed on the system are designated by a user,
when information indicating a destination of the system designated by the user and information indicating the operation designated by the user are not stored in the memory in an associated manner, requesting a name resolution system to perform name resolution based on the information indicating the destination of the system designated by the user and accessing the system according to an address acquired in response to the request; and
when the information indicating the destination of the system designated by the user and the information indicating the operation designated by the user are stored in the memory in an associated manner, not requesting a name resolution system to perform name resolution based on the information indicating the destination of the system designated by the user.

5. An information processing method comprising:
by a computer including a memory configured to store information indicating a destination of an access destination system and information indicating an operation prohibited for the access destination system in an associated manner,
in a case where an access destination system and an operation to be performed on the system are designated by a user,
when information indicating a destination of the system designated by the user and information indicating the operation designated by the user are not stored in the memory in an associated manner, requesting a name resolution system to perform name resolution based on the information indicating the destination of the system designated by the user and accessing the system according to an address acquired in response to the request; and
when the information indicating the destination of the system designated by the user and the information indicating the operation designated by the user are stored in the memory in an associated manner, not requesting a name resolution system to perform name resolution based on the information indicating the destination of the system designated by the user.
